(19) United States
(12) Patent Application Publication
(10) Pub. No.: US 2023/0166202 A1
(43) Pub. Date: Jun. 1, 2023

(54) A FILTER PLATE FOR A HORIZONTAL PLATE AND FRAME-TYPE FILTER, SUCH AS A TOWER PRESS

(71) Applicant: Metso Outotec Finland Oy, (US)

(72) Inventors: Mirva MUSTAKANGAS, Pirkkala (FI); Ismo JUVONEN, Rauha (FI); Janne KAIPAINEN, Halsua (FI); Teemu ELORANTA, Luumäki (FI); Mika ILLI, Vantaa (FI); Kari VÄNTTINEN, Espoo (FI)

(73) Assignee: Metso Outotec Finland Oy, Tampere (FI)

(21) Appl. No.: 17/918,016

(22) PCT Filed: Jun. 3, 2020
(86) PCT No.: PCT/FI2020/050391

§ 371 Date: Oct. 10, 2022

(51) Int. Cl. B01D 25/21; B01D 25/30; B01D 25/164

(52) U.S. Cl. CPC B01D 25/215; B01D 25/305; B01D 25/1645

(57) ABSTRACT

A filter plate for a horizontal plate and frame-type filter, such as a tower press. A filtrate vat formed on, and integral with a filter plate is provided along with an outlet opening as a gap on a border delimiting the vat for providing drainage route, and a recessed portion provided at the outlet opening. A rigid structure of the filtrate vat that is capable of resisting deformation may be achieved, and contamination from slurry between the filter plate and a possible vat liner or coating is avoided.

### CROSS-REFERENCE TO RELATED APPLICATIONS

This application is the U.S. national stage application of International Application PCT/FI2020/050391, filed Jun. 3, 2020, which international application was published on Dec. 9, 2021, as International Publication WO 2021/245323 A1 in the English language.

### FIELD OF THE DISCLOSURE

The present disclosure relates to horizontal plate and frame-type filters, such as tower presses, and more particularly to a filter plate for such a filter.

### BACKGROUND OF THE DISCLOSURE

In conventional horizontal filter plate and frame-type filters, such as tower presses, filtrate is collected to a filtrate vat from a filter chamber formed above the vat. The filtrate vat has typically been provided as a separate, replaceable component forming a receptacle for receiving the filtrate, and has been placed on top of a substantially flat filter plate.

However, it has been noticed, that such a wear resistant separate filtrate vat is prone to creeping under as it is repetitively compressed over numerous filtration cycles. Creeping of the vat subsequently lead to problems related to sealing the filtrate vat against a filter plate assembly above. Worn filtrate vat have thus been replaced after becoming excessively deformed. Moreover, it has not been generally considered feasible to change the material of the filtrate vat so as to better resist deformation due to creeping, because this has been considered to result in unsatisfactory wear-resistance characteristics caused by the abrasive nature of the finer particles carried by the slurry, and a possible subsequent drying air flow.

It has also been noted that conventional, separate filtrate vats have faced issues related to contamination from the slurry to be filtered and other process fluids. Particularly, slurry that has reached the interface between the filter plate and the filtrate vat may travel underneath the filtrate vat due to the capillary effect and the repetitive compression of the filtration cycles. Such impurities cause a bulge on the otherwise flat filter plate, thereby leading to premature wear of the filtrate vat and even breakage thereof. Moreover, slurry or other process fluid contamination may corrode fasteners used to attach the filtrate vat to the filter plate, thereby hindering the maintenance of the associated filter, such as replacement of the filtrate vat.

### BRIEF DESCRIPTION OF THE DISCLOSURE

An object of the present disclosure is to provide a filter plate which provides a solution to the problems associated with conventional, separate filtrate vats, as discussed above.

The object of the disclosure is achieved by the filter plate which is characterized by what is stated in the independent claims. The preferred embodiments of the disclosure are disclosed in the dependent claims.

The disclosure is based on the idea of providing the filtrate vat formed on, and integral with the filter plate along with an outlet opening as a gap on the border for providing drainage route, and a recessed portion provided at the outlet opening. In this way, a rigid structure of the filtrate vat capable of resisting deformation may be achieved, and contamination from slurry between the filter plate and a possible vat liner or coating is avoided.

### BRIEF DESCRIPTION OF THE DRAWINGS

In the following the disclosure will be described in greater detail by means of preferred embodiments with reference to the accompanying drawings, in which

FIG. 1 illustrates a plan view of a filter plate according to an embodiment of the present disclosure.

FIG. 2 illustrates a cross-sectional cut view along the dashed cut line illustrated in FIG. 1;

FIG. 3 illustrates the filter plate FIG. 1, as seen as a perspective view;

FIG. 4 illustrates a filter plate assembly having the filter plate of FIG. 1 equipped with a vat liner and a grid as seen as a plan view;

FIG. 5 illustrates the filter plate assembly of FIG. 4 as an exploded cut view along the dashed cut line illustrated in FIG. 4, and

FIG. 6 illustrates the arrangement of FIG. 6 in a non-exploded configuration.

### DETAILED DESCRIPTION OF THE DISCLOSURE

According to a first aspect of the present disclosure, a filter plate 1 for a filter plate assembly of a horizontal plate and frame-type filter, such as a tower press, is provided.

The filter plate 1 has a rigid plate-like body with a frame side 1a and a vat side 1b. The frame side 1a is intended to face towards a plate frame, on which the filter plate is supported, when in use, whereas the vat side 1b is intended to face towards a filter chamber formed by the filter plate assembly together with an adjacent filter plate assembly above.

The filter plate 1 comprises, on the vat side 1b, a border 2 having at least an inner lateral wall 2a and an upper surface 2b. The border 2 is elevated for a distance at least from a portion of the filter plate 1 delimited within the border 2.

Particularly, a filtrate vat 3 is formed by the filter plate 1, such that the inner lateral wall 2a of the border forms a lateral wall of the filtrate vat 3, and a portion of the filter plate delimited by the border 2 forms a bottom of the filtrate vat 3. That is, a receptacle for receiving filtrate is formed by the shape of the filter plate 1 itself.

A gap 2d is provided on the border 2, such that an outlet opening extending laterally through the border 2 is formed. In this way, a fluid drainage route is provided from the filtrate vat 3. Furthermore, the filter plate 1 comprises, on the vat side 1b thereof, a recessed portion 1c situated at the outlet opening, the recessed portion 1c being recessed with respect to the bottom of the filtrate vat 3. Such a configuration of the drainage route enables a more simple and serviceable structure as compared to an arrangement in which the fluid drainage route is provided vertically through the filter plate 1.

Preferably, but not necessarily, the filter plate 1 may have a vat area of between 1.5 m²-9 m². More preferably, but not necessarily, the filter plate 1 may have a vat area of between 2.5 m²-7 m². Most preferably, but not necessarily, the filter plate 1 may have a vat area of between 2.5 m²-7 m². In the context of this disclosure, the vat area is defined as the area of the portion of the filter plate 1 delimited by the border 3, i.e. the bottom of the filtrate vat 3.

Preferably, but not necessarily, the border 2, particularly the upper surface 2b thereof, may be elevated for a distance of at least 10 mm from the portion of the filter plate 1 delimited within the border, i.e. the bottom of the filtrate vat 3. Preferably, but not necessarily, the border 2, particularly the upper surface 2b thereof, may be elevated for a distance of no more than 40 mm from the portion of the filter plate 1 delimited within the border. For example, the border 2, particularly the upper surface 2b thereof, may be elevated for a distance of 15-20 mm from the portion of the filter plate 1 delimited within the border.

Preferably but not necessarily, the border 2 has a width of at least 15 mm. Preferably, but not necessarily, the border has a width of no more than 200 mm. For example, the width of the border 2 may be between 75 mm-100 mm. In the context of this disclosure, the width of the border 2 refers to a transverse dimension thereof, parallel with the bottom of the filtrate vat 3. Also, it should be noted, that the border 2 may have different widths at different parts of the filter plate 1.

Preferably, but not necessarily, the filter plate 1 may have an average material thickness of between 8 mm-30 mm at the portion thereof delimited by the border 2.

Most suitably, the filter plate 1 is of a rigid material able to resist creeping. Examples of such materials of the filter plate 1 include, but are not limited to, metals, such as steel, FRP (fibre-reinforce plastics) materials, such as reinforced composite materials with a thermoset or thermoplastic matrix, and thermoset materials.

In this way, the filter plate 1 may be constructed so as to provide a rigid structure forming the shape of the filtrate vat 3 being able to resist deformation due to creeping.

In an embodiment according to the first aspect of the present disclosure, the border 2 has an outer lateral wall 2c. In other words, the border 2 is also elevated with respect to an area of the filter plate 1 surrounding the border 2.

In such a case, the border 2 is preferably, but not necessarily, elevated from the filter plate 1 on both sides of the border 2 for an equal distance. That is, the border 2 is equally elevated from the area of the filter plate 1 surrounding the border 2 and the area of the filter plate 1 delimited by the border 2.

In an embodiment according to the present disclosure, the border 2 is solid. In other words, the border does not have a hollow structure.

In an embodiment according to the first aspect of the present disclosure, the one or more gaps 2d have a length of between 150 mm-300 mm in the longitudinal direction of an associated side (e.g., 2d, 2e, 2f, 2g) on which the gap 2d is situated.

In an embodiment according to the first aspect of the present disclosure, the one or more gaps 2d may have a height corresponding to that of the border 2 (i.e., elevation from the area of the filter plate 1.

In an embodiment according to the first aspect of the present disclosure, the filter plate 1 is of a generally rectangular shape having a first flank side 1d and a second flank side 1e parallel to the first flank side 1d, and a first end side 1f and a second end side 1g parallel to the first end side 1f. Moreover, the first and second end sides 1f, 1g extend in a direction transverse to a direction in which the first and second flank sides 1d, 1e extend, and the first and second flank sides 1d, 1e have a length greater than that of the first and second end sides 1f, 1g.

In such a case, one or more gaps 2d of the border 2 are formed on either or both of the first flank side 1d and the second flank side 1e.

Preferably, but not necessarily, the length of the first and second flank sides 1d, 1e is between 1.5-3 times of that of the first and second end sides 1f, 1g, respectively

Preferably, but not necessarily, one or more gaps 2d of the border 2 are formed in a corner region between a flank side 1d, 1e and an end side 1f, 1g.

Preferably, but not necessarily, the filter plate comprises one or more lateral indentation portions 1i provided on either or both of the first flank side 1d and the second flank side 1e. Such lateral indentation portions 1i are arranged to circumvent suspension elements and/or support elements of a filter plate frame on which the filter plate 1 is supported.

Such an arrangement facilitates maintenance by allowing the filter plate 1 to be removed from a plate frame on which it is supported without removing the plate frame from the filter apparatus.

The filter plate 1 may additionally comprise one or more lateral widening portions 1j provided on either or both of the first flank side 1d and the second flank side 1e. The lateral widening 1j portions are arranged between lateral indentation portions 1i adjacent to the widening portion 1j. Moreover, the lateral widening portions 1j are arranged to laterally overhang a filter plate frame supporting the filter plate 1.

Such an arrangement further facilitates maintenance by allowing the filter plate 1 to be lifted at the lateral widening portions 1j.

In an embodiment according to the first aspect of the present disclosure, the filter plate 1 comprises a plurality of attachment holes 1h running along the periphery of the filter plate 1 and extending therethrough. The attachment holes 1h are situated on an outer side of the border 2 with respect to the filtrate vat 3, such that the attachment holes 1h are not in contact with filtrate within the filtrate vat, when in use.

Such an arrangement facilitates maintenance, as the attachment holes, through which the filter plate 1 is attached to the plate frame are less like to be contaminated form slurry, filtrate ort other process fluids. Consequently, any fasteners used for attaching the filter plate to the plate frame are less likely to seize.

In an embodiment according to the first aspect of the present disclosure, at least the filtrate vat 3 is coated or lined with a vat liner 4. Most suitably, also the inner lateral wall 2a is coated or lined with the vat liner 4. The coating or vat liner 4 is of a wear-resistant material chosen from a group comprising wear resistant polymers, such as thermoplastics including thermoplastic vulcanizates and thermoplastic elastomers, PUR and rubber.

Preferably, but not necessarily, the coating or vat liner 4 additionally covers either or both of the upper surface 2b and the outer lateral wall 2c of the border 2.

Preferably, but not necessarily, the coating or vat liner 4 additionally at least partially covers the gap 2d.

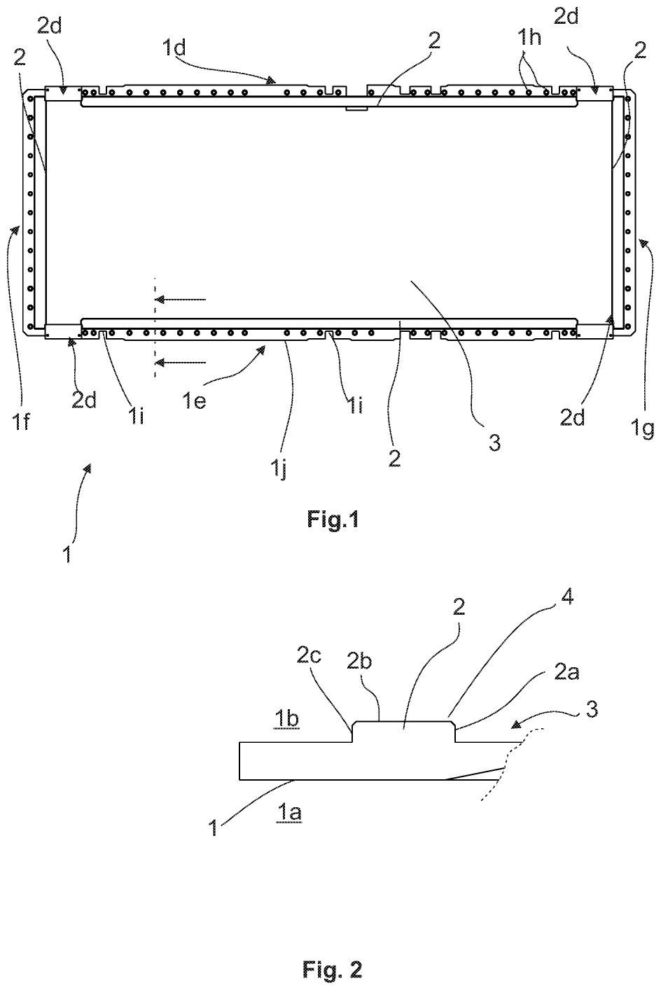

FIG. 1 illustrates a plan view of a filter plate according to an embodiment of the present disclosure. Particularly, FIG. 1 shows the filter plate 1 as seen from the vat side 1b. The filter plate 1 is of a rectangular shape having a first flank side 1d, a second flank side 1e, a first end side 1f and a second end side 1g.

A border 2 on the vat side 1b runs along the first and second flank and end sides 1d-1g. A filtrate vat 3 is formed in the central are of the filter plate 1, delimited by the border 2.

Gaps 2d of the border are situated in the corner regions between adjacent flank sides 1d, 1e and end sides 1f, 1g, respectively.

The flank sides 1d, 1e have indented portions 1i, which are laterally recessed with respect to adjacent portions of the filter plate 1, and widening portions 1j, which extend laterally further with respect to their adjacent portions. The widening portions 1j are provided between indented portion 1i, although other configurations are foreseeable. Attachment holes 1h can be seen extending around the periphery of the filter plate 1.

FIG. 2 illustrates a cross-sectional cut view along the cut line illustrated in FIG. 1 (i.e., running across the second flank side 1e). Particularly, FIG. 2 illustrates the cross-sectional profile of the border 2 integrally formed by the filter plate 1. The upper surface 2b of the profile is elevated from the area of filter plate 2 both delimited. The inner lateral wall 2a of the border laterally delimits an area of the filter plat 2 forming the filtrate vat 3. The outer lateral wall 2c extends from the upper surface 2b of the border 2 towards the area of the filter plate 2 surrounding the border 2.

Although not illustrated in FIG. 2, the filter plate 1 may be supported on a plate frame.

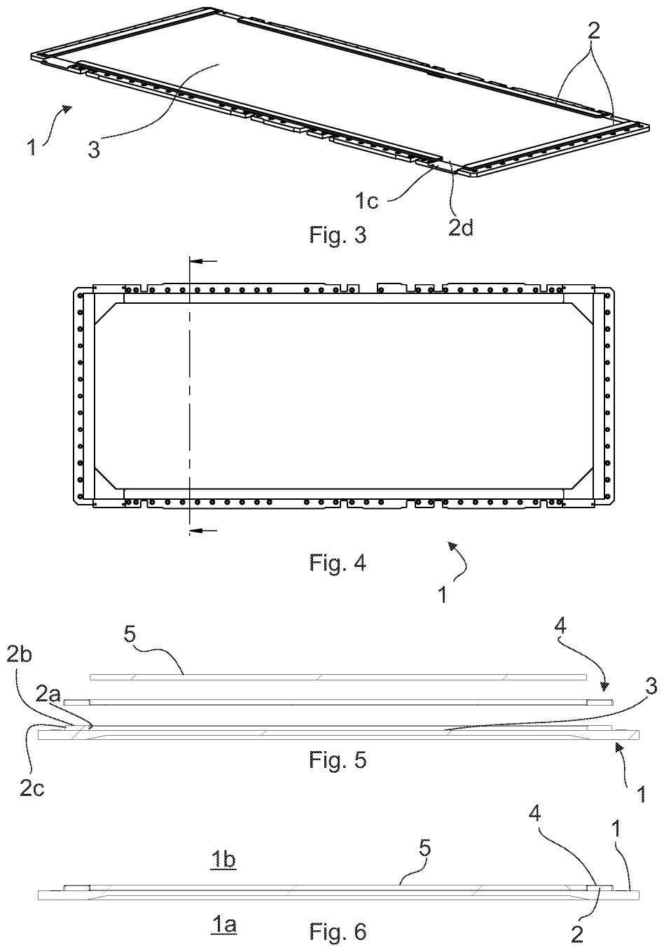

FIG. 3 illustrates the filter plate of FIG. 1 as seen as a perspective view. Particularly FIG. 3 more clearly shows how the filtrate vat 3 is formed by the filter plate 2 and delimited by the border 2 thereof. Moreover, the drainage routes provided by the gaps 2d of the border can be seen, in addition to the recessed portions 1c of the filter plate 1

FIG. 4. illustrates a filter plate assembly having the filter plate of FIG. 1 equipped with a vat liner 4 and a grid 5, which is illustrated in more detail in the cut views of FIG. 5 and FIG. 6, as seen along the dashed cut line shown in FIG. 4. Particularly, FIG. 5 is shown in an exploded configuration, whereas FIG. 6 is shown in a non-exploded configuration.

FIG. 5 and FIG. 6 further illustrate how the shape of the filtrate vat 3 is formed by the by the filter plate 1 and the border 2 thereof, whereas the vat liner 4 merely acts as a lining following the shape of the actual filtrate vat 3. Moreover, these drawings illustrate how the vat liner 4 is tightly seated together with the filtrate vat 3 and the border 2, and how a grid 5 may be received in the filtrate vat 3, above the vat liner 4.

### LIST OF REFERENCE NUMERALS

1 filter plate
1a frame side
1b vat side
1c recessed portion
1d first flank side
1e second flank side
1f first end side
1g second end side
1h attachment holes
1i indented portion
1j widening portion
2 border
2a inner lateral wall
2b upper surface
2c outer lateral wall
2d gap
3 filtrate vat
4 vat liner
5 grid

1-15. (canceled)

16. A filter plate for a horizontal plate and frame-type filter, such as a tower press, the filter plate having a rigid plate-like body with a frame side and a vat side,
wherein the filter plate comprises, on the vat side, a border having at least an inner lateral wall and an upper surface, the border being elevated for a distance at least from a portion of the filter plate delimited within the border, and
wherein the border is an integral part of the filter plate,
wherein a filtrate vat is formed by the filter plate, such that the inner lateral wall of the border forms a lateral wall of the filtrate vat, and a portion of the filter plate delimited by the border forms a bottom of the filtrate vat,
wherein a gap is provided on the border, such that an outlet opening extending laterally through the border is formed, thereby providing a fluid drainage route from the filtrate vat, and wherein the filter plate comprises, on the vat side of the filter plate, a recessed portion of the filter plate situated at the outlet opening, the recessed portion being recessed with respect to the bottom of the filtrate vat.

17. The filter plate according to claim 16, wherein the border is elevated for a distance of between 10 mm-40 mm from the portion of the filter plate delimited within the border.

18. The filter plate according to claim 16, wherein the width of the border is between 15 mm-200 mm.

19. The filter plate according to claim 16, wherein the border has an outer lateral wall, wherein the border is elevated for a distance at least from a portion of the filter plate delimiting the border.

20. The filter plate according to claim 16, wherein the border is solid.

21. The filter plate according to claim 16, wherein the length of the gap is between 150 mm-300 mm.

22. The filter plate according to claim 16, wherein the filter plate is of a generally rectangular shape having a first flank side and a second flank side parallel to the first flank side, and a first end side and a second end side parallel to the first end side,
wherein the first and second end sides extend in a direction transverse to a direction in which the first and second flank sides extend,
wherein the first and second flank sides have a length greater than that of the first and second end sides, and
wherein one or more gaps of the border are formed on either or both of the first flank side and the second flank side.

23. The filter plate according to claim 22, wherein the length of the first and second flank side is 1.5 to 3 times that of the first and second end side.

24. The filter plate according to claim 22, wherein a gap of the border is formed in a corner region between a flank side and an end side.

25. The filter plate according to claim 22, wherein the filter plate comprises one or more lateral indentation portion provided on either or both of the first flank side and the second flank side,
wherein the lateral indentation portion is arranged to circumvent suspension elements and/or support elements of a filter plate frame on which the filter plate is to be supported.

26. The filter plate according to claim 25, wherein the filter plate comprises one or more lateral widening portions provided on either or both of the first flank side and the second flank side,
wherein the lateral widening portions are arranged between lateral indentation portions adjacent to the widening portion,
wherein the lateral widening portions are arranged to laterally overhang a filter plate frame intended to support the filter plate.

27. The filter plate according to claim 16, wherein the filter plate comprises a plurality of attachment holes running along the periphery of the filter plate and extending therethrough,
wherein the attachment holes are situated on an outer side of the border with respect to the filtrate vat, such that the attachment holes are not in contact with filtrate within the filtrate vat, when in use

28. The filter plate according to claim 16, wherein the filter plate is of creeping-resistant material, chosen from a group comprising metals, such as steel, FRP (fibre-reinforce plastics) materials, such as reinforced composite materials with a thermoset or thermoplastic matrix, and thermoset materials.

29. The filter plate according to claim 16, wherein at least the filtrate vat is coated or lined with a vat liner the coating or vat liner being of a wear-resistant material chosen from a group comprising wear resistant polymers, such as thermoplastics including thermoplastic vulcanizates and thermoplastic elastomers, PUR and rubber.

30. The filter plate according to claim 29, wherein the coating or vat liner additionally covers either or both of the upper surface and the outer lateral wall of the border.
